(19) United States
(12) Patent Application Publication
(10) Pub. No.: US 2004/0027231 A1
(43) Pub. Date: Feb. 12, 2004

(54) Multi-directional input and electronic equipment using the device

(76) Inventors: Hiroto Inoue, Kyoto (JP); Tamotsu Yamamoto, Hyogo (JP)

Correspondence Address: RATNERPRESTIA, P O BOX 980, VALLEY FORGE, PA, 19482-0980, US

(21) Appl. No.: 10/363,814

(22) PCT Filed: Jul. 3, 2002
(86) PCT No.: PCT/JP02/06725

(30) Foreign Application Priority Data
Jul. 23, 2001 (JP) 2001221099

(51) Int. Cl. H01C 10/10

(52) U.S. Cl. 338/47; 338/128

(57) ABSTRACT

In a multiple-direction input device, when the operation body is tilted, a push portion having a substantially spherical shape at the bottom of a operation body pushes a resistor element and detects a tilting direction and a tilting angle of the operation body from a resistance at a pressing point. Thus, the input device may operate in multiple directions in entire directions of 360°. The device can detect the pressing point of the push portion pressing the resistor element in accordance with the tilting direction and the tilting angle. The multiple-direction input device using less number of parts is capable of continuously detecting the tilting directions and the tilting angles.

### TECHNICAL FIELD

The present invention relates to a multiple-direction input device for input operation of electronic apparatuses, such as cellular phones, information terminals, game machines, and remote controllers, and the electronic apparatuses using the device.

### BACKGROUND ART

Electronic apparatuses are having enhanced function and are diversified, and includes operating function by push-button operation or like operation, provided with various functions, such as selection and decision of a menu shown in a display, such as an LCD with a multiple-direction switch increase.

A conventional multiple-direction input device will be described with reference to FIG. 13 to FIG. 15.

FIG. 13 is a sectional view of the conventional multiple-direction input device. Operation knob 2A at the upper part of operation button 2 made of insulating resin protrudes out of circular hole 1A at the top of upper case 1 made of insulating resin. Support portion 2B protrudes at the lower center of the operation knob 2 contacts support hole 3A provided in wiring board 3 having wiring patterns (not shown) formed on the top and bottom surfaces the board. Four push-button switches 4 are mounted at the front, rear, right, and left around support hole 3A as a center on the upper surface of the wiring board 3. The operation button 2 can be tilted forward, backward, rightward, and leftward with a fulcrum, i.e., support portion 2B. Push portion 2C disposed at the lower periphery end of the operation button 2 contacts the top surfaces of respective operation portions 4A of the four push-button switches 4.

The multiple-direction input device is, as shown in the plan view of FIG. 14, installed in the middle of an electronic apparatus including a display 6, such as LCD, and push-buttons 7. The push-button switches 4 are electrically connected with a controller, such as microcomputer 8.

For example, as shown in FIG. 15, the operation button 2, upon being tilted to the left, has the push portion 2C at the left periphery end of the operation button 2 push the operation shaft 4A of the push-button switch 4 at the left, thus making the push-button switch 4 conductive. Then, a signal showing the conductive is input to the microcomputer 8, and the microcomputer 8 distinguishes which one of the push-button switches 4 is conductive. Thus, the microcomputer 8 detects the tilting direction of the operation button 2, i.e., forward, backward, rightward or leftward, and selects from a menu shown on the display 6.

However, when the conventional multiple-direction input device is intended to detect the operations in more directions, the device needs more push-button switches, thus including more components. The device can detect only the tilting direction but can not detect the amount of tilt or the tilting angle.

### SUMMARY OF THE INVENTION

A multiple-direction input device includes an operation body having a push portion at a bottom thereof, the push portion having a substantially spherical shape, and a flat resistor element beneath the operation body, for providing a resistance that changes according to a tilting direction and a tilting angle of the operation body pushed by the push portion.

The multiple-direction input device uses less number of parts and can continuously detect a tilting direction and a tilting angle of the operation body.

### BRIEF DESCRIPTION OF THE DRAWINGS

FIG. 1 is a sectional view of a multiple-direction input device according to exemplary embodiment 1 of the present invention.

FIG. 2 is an exploded perspective view of the multiple-direction input device according to embodiment 1.

FIG. 3 is a block circuit diagram of an essential portion of the multiple-direction input device according to embodiment 1.

FIG. 4 is a sectional view in pushing operation of the multiple-direction input device according to embodiment 1.

FIG. 5 is a sectional view in tilting operation of the multiple-direction input device according to embodiment 1.

FIG. 6 is a sectional view in tilting operation of the multiple-direction input device according to embodiment 1.

FIG. 7 is a conceptual diagram of a contact position recognizing method of the multiple-direction input device according to embodiment 1.

FIG. 8 is a conceptual diagram of a contact position recognizing method of the multiple-direction input device according to embodiment 1.

FIG. 9 is a sectional view of a multiple-direction input device according to exemplary embodiment 2 of the invention.

FIG. 10 is a block circuit diagram of an essential portion of the multiple-direction input device according to embodiment 2.

FIG. 11 is a sectional view in pushing operation of the multiple-direction input device according to embodiment 2.

FIG. 12 is an exploded perspective view of an essential portion of another multiple-direction input device according to embodiment 2.

FIG. 13 is a sectional view of a conventional multiple-direction input device.

FIG. 14 is a plan view of an electronic apparatus including the conventional multiple-direction input device.

FIG. 15 is a sectional view in tilting operation of the conventional multiple-direction input device.

### DETAILED DESCRIPTION OF PREFERRED EMBODIMENTS

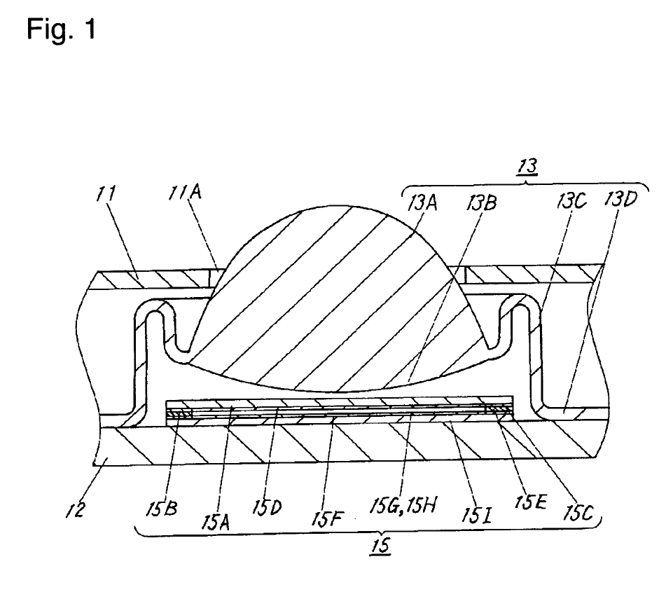

Exemplary embodiments of the present invention will be described with reference to FIG. 1 to FIG. 12. Parts identical to those described in the section of prior art are denoted by identical reference numerals, and their detailed description is omitted.

(Exemplary Embodiment 1)

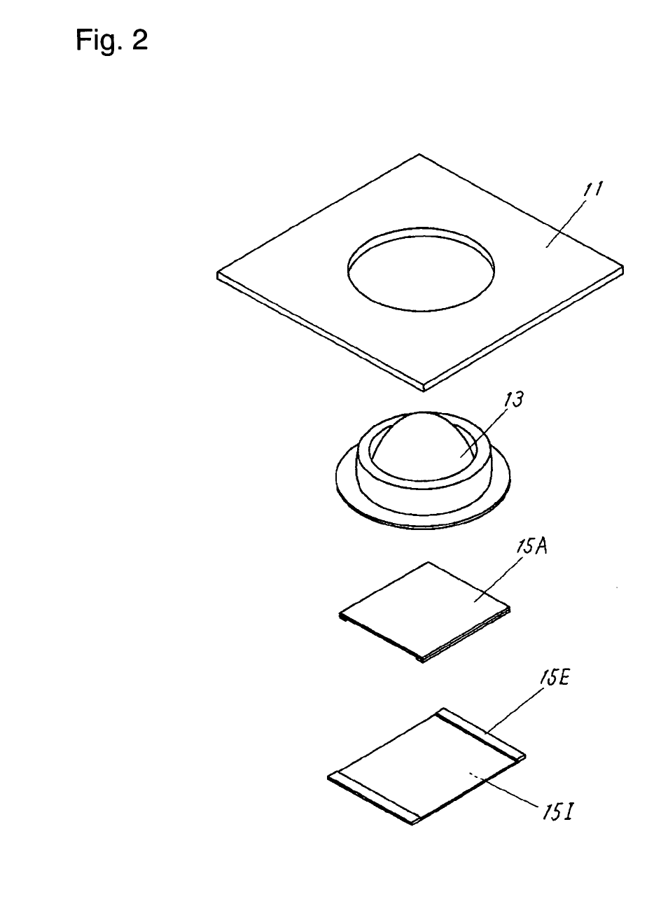

FIG. 1 is a sectional view of a multiple-direction input device according to exemplary embodiment 1 of the present invention. FIG. 2 is an exploded perspective view of the device. Operation knob 13A at the upper part of operation body 13 made of insulating resin protrudes out of circular hole 11A at the top of upper case 11 made of insulating resin. Push portion 13B having a substantially spherical shape is located at the bottom of the operation body 13. Resistor elements 15 placed on wiring board 12 are arranged a space apart from each other under the push portion 13B. The resistor element 15 includes top board 15A disposed at the top that is a film of polyethylene phthalate or the like having flexibility, electrodes 15B and 15C disposed at the right and left ends of the underside of the top board 15A, upper resistor layer 15D formed by dispersing carbon or the like in resin which is printed between the electrode 15B and the electrode 15C, bottom board 151 that is a film of polyethylene phthalate or the like having flexibility, electrodes 15G and 15H disposed at the front and rear ends of the top surface of the board 151, lower resistor layer 15F made of the same material as the upper resistor layer 15D which is printed between the electrode 15G and the electrode 15H, and spacer 15E having an adhesive coat on its top and bottom surfaces. The top board 15A and the bottom board 151 are bonded to each other by the spacer 15E. The upper resistor layer 15D and the lower resistor layer 15F face each other at a predetermined interval. Outer periphery portion 13D unitarily formed with the operation knob 13A and the push portion 13B via elastic thin portion 13C of the operation body 13 is located on the wiring board 12 having patterns (not shown) formed on the top and bottom surfaces. A predetermined space is provided between the push portion 13B and the top board 15A of the resistor element 15.

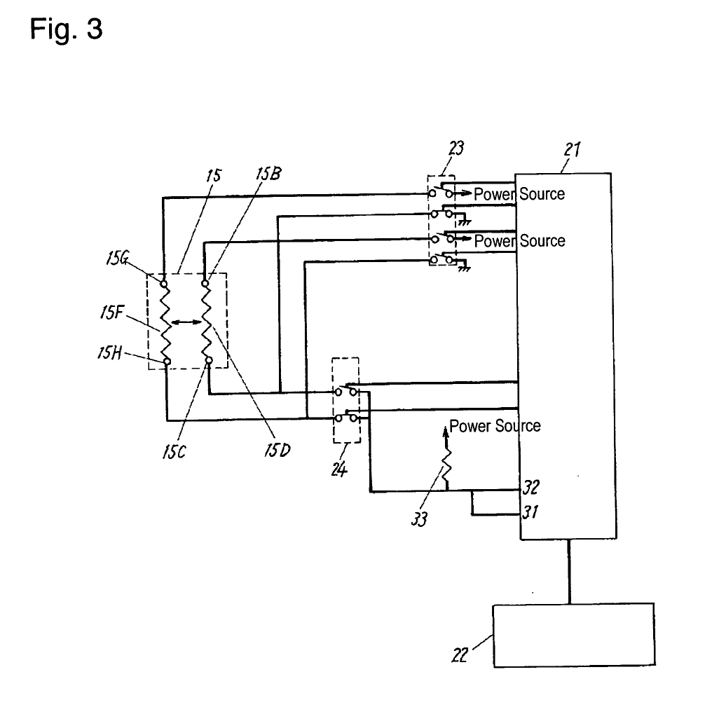

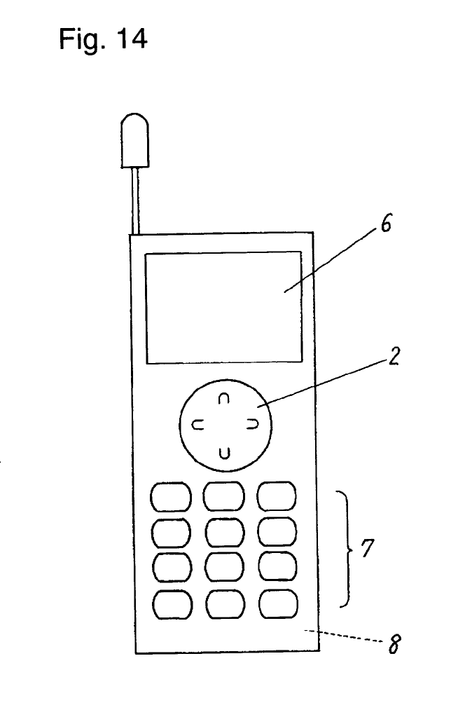

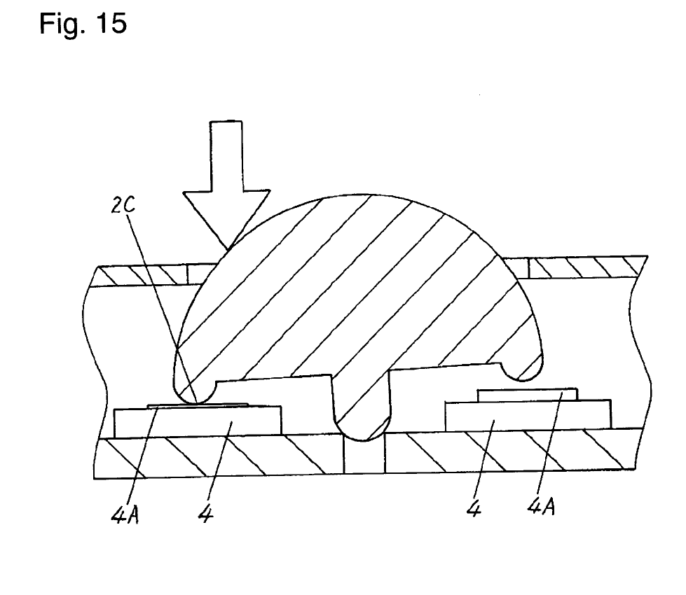

The multiple-direction input device is, as shown in FIG. 14, installed in an electronic apparatus having the display 6, such as LCD and push-buttons 7. As shown in the block circuit diagram of the electronic apparatus shown in FIG. 3, the electrodes 15B, 15C, 15G, and 15H of the resistor element 15 are connected to a controller including microcomputer 21 or the like via analog switch 23 that is an integrated circuit of a transistor or the like.

A resistance between electrode 15B and electrode 15C facing each other and a resistance between electrode 15G and electrode 15H are about 10 kΩ.

The microcomputer 21 is provided with interrupt-input terminal 31 for detecting the start of pushing operation of the operation body 13, and A/D-input terminal 32 for reading an analog voltage to detect a pushed portion. Each terminal is commonly connected to analog switch 24, and resistor 33 of about 2 MΩ is connected between the terminal and a power source.

An input operation of the multiple-direction input device of the electronic apparatus will be described.

First, in case of no pushing operation of the operation body 13, the microcomputer 21 controls the analog switch 23 to connect the electrode 15C of the upper resistor layer 15D to a ground and to disconnect the electrode 15B of the upper resistor layer 15D, the electrodes 15G and 15H of the lower resistor layer 15F. The microcomputer 21 also controls the analog switch 24 to connect the electrode 15H to the interrupt-input terminal 31 and to disconnect the electrode 15C.

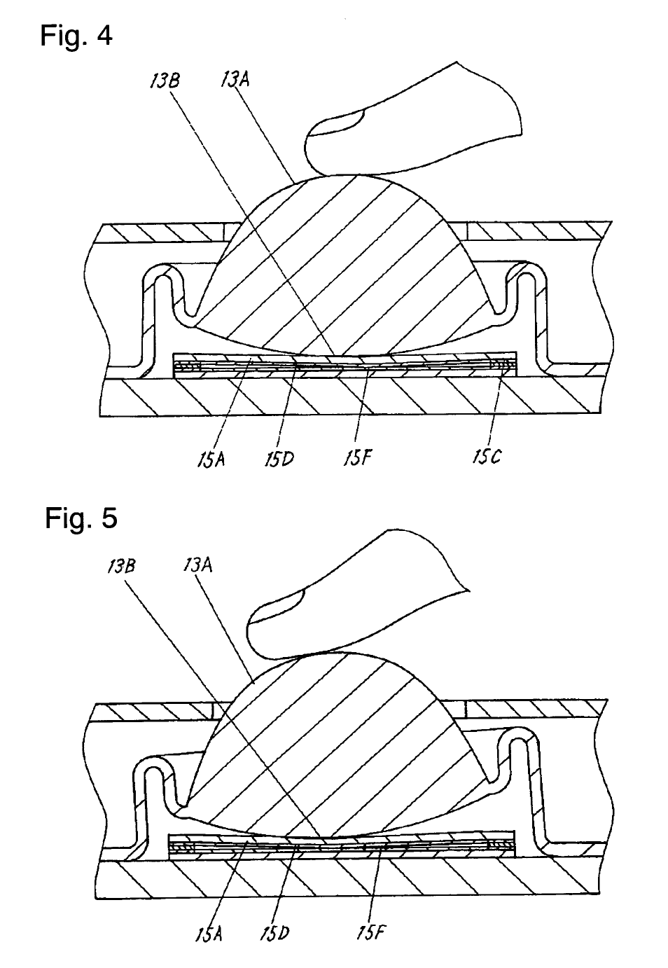

Then, as shown in the sectional view of FIG. 4, for example, when the operation knob 13A is pushed with a finger or the like, the central portion of the push portion 13B pushes the top board 15A, thus having the central portion of the upper resistor layer 15D underneath the top board 15A contact the central portion of the lower resistor layer 15F opposing to the layer 15D. Thus, as shown in FIG. 3, a current flows from the power source to the electrode 15C at the ground via the resistor 33. Then, the potential of the input terminal 31 of the microcomputer 21 is connected to a ground potential changed from a power source potential. Thereby, the microcomputer 21 recognizes the start of pushing operation of the operation body 13.

Subsequently, as shown in the sectional view of FIG. 5, when the upper part of the operation knob 13A of the operation body 13 is tilted to the left with the finger, the operation body 13 pressed downward turns to the left on a pressing point at the center of the push portion 13B as a fulcrum. Then the pressing point pressing the resistor layer 15 moves to the left from the center of the push portion 13B.

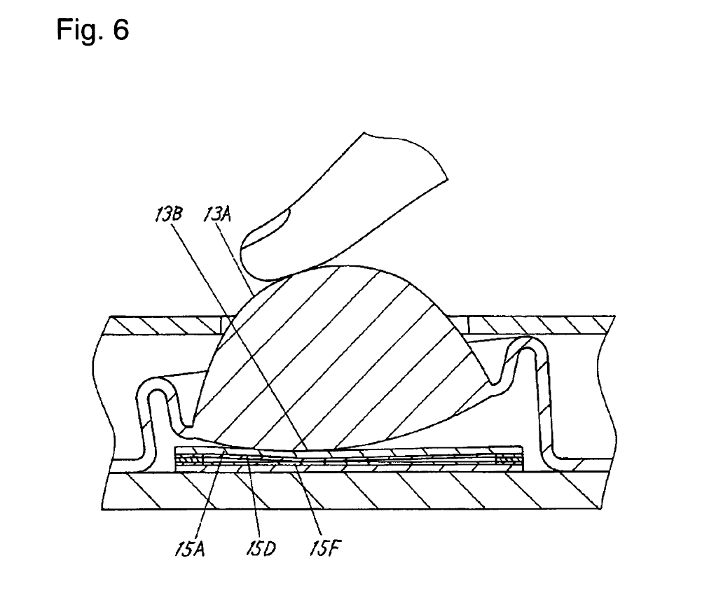

As shown in the sectional view of FIG. 6, when the knob is further tilted to the left, the operation body 13 turns further to the left on the pressing point of the push portion 13B, and then, the pressing point pressing the resistor layer 15 moves further to the left.

Similarly to this, when the operation body 13 is tilted to the right, forward, or backward, the pressing point pressing the resistor layer 15 of the operation body 13 moves in accordance with the direction of tilt and the angle of turn.

That is, the operation body 13 turns on the push portion 13B having a substantially-spherical shape, and then, the pressing point pressing the resistor layer 15 moves in various directions of tilt and the angles of turn in rightward, leftward, forward, and backward. That is, the operation body 13 presses a specific point of the resistor layer 15 in accordance with the direction of tilt and the angle of turn in entire directions of 360°.

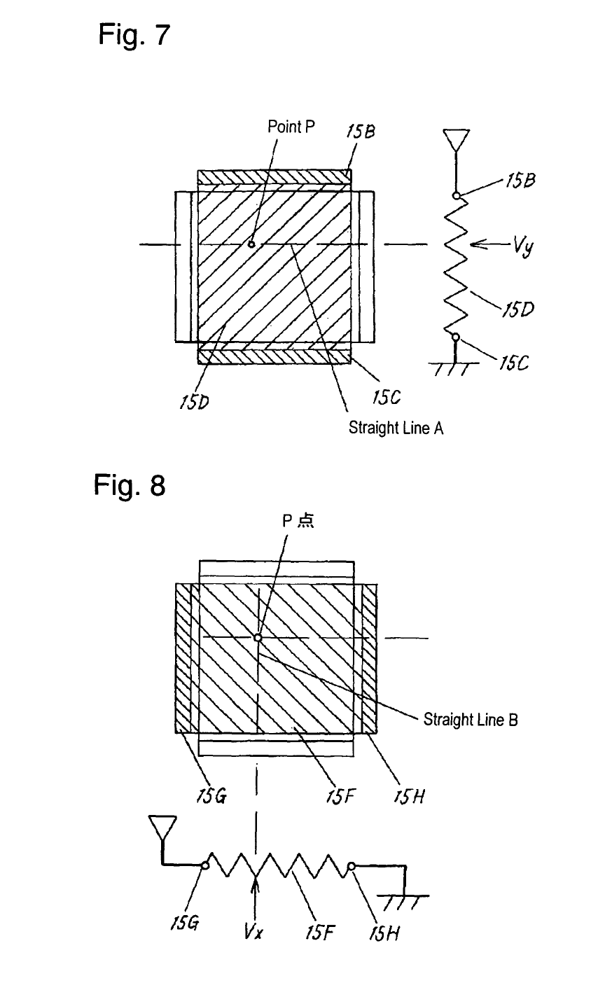

When the operation body 13 is tilted as described above, the microcomputer 21 controls the analog switch 23 to connect the electrode 15B of the upper resistor layer 15D to the power source, and applies a current to the electrode 15C at the ground from the electrode 15B, and then reads the voltage of the electrode 15C from the A/D-input terminal 32. As shown in the conceptual diagram of FIG. 7, from the read voltage Vy, the microcomputer 21 recognizes that the position of a point P, i.e., the pressing point of the push portion 13B is located on a straight line A between the electrode 15B and the electrode 15C.

Next, the microcomputer 21 controls the analog switch 23 to disconnect the electrode 15B and electrode 15C of the upper resistor layer 15D, to connect the electrode 15G of the lower resistor layer 15F to the power source, and to connect the electrode 15H to the ground. Thus, a current flows between the terminals of electrode 15G and electrode 15H of the lower resistor layer 15F. The microcomputer 21 controls the analog switch 24 to connect the electrode 15H to the A/D-input terminal 32, and then reads a voltage Vx of the electrode 15H from the A/D-input terminal 32. In this case, as shown in the conceptual diagram of FIG. 8, from the read voltage Vx, the microcomputer 21 recognizes that the position of the point P is located on the straight line B between the electrode 15G and the electrode 15H.

From these results, the microcomputer 21 judges that the pushing operation has been executed at the position of point P, the intersection of straight line A and straight line B. And, the microcomputer 21 processes the data of the position of point P and recognizes the tilting direction and the tilting angle of the operation body 13.

Such operation of the multiple-direction input device causes the menu shown on the display 22 of the electronic apparatus to change in accordance with the operating direction or the displayed cursor and pointer to move.

Further, as the operation body 13 tilted at a predetermined angle, a displayed cursor and pointer may moved slowly by the microcomputer 21. And as the operation body 13 tilted further more, the displayed cursor and pointer may move faster. That is, in the electronic apparatus, the moving speed of the displayed cursor and pointer can be changed according to the tilting angle of the operation body 13.

Also, a predetermined space may be provided between the push portion 13B at the bottom of the operation body 13 and the resistor element 15 in order to execute pushing operation as well as tilting operation of the operation body 13. The microcomputer 21 may recognize the start of operation of the operation body 13 by reading the resistance at the time of pushing operation.

Further, besides the selection of a menu with the tilting operation, the electronic apparatus may finalize the selection when the operation body is pushed with a menu.

In this multiple-direction input device, a controller is connected to the resistor element, and the tilting direction and angle of the operation body are detected from the resistance of the resistor element 15. Thus, the electronic apparatus used easily and being capable of executing multi-directional operations and of detecting the directions, angles, and operational loads.

(Exemplary Embodiment 2)

The same components as those in embodiment 1 are denoted by the same reference numerals, and their detailed description is omitted.

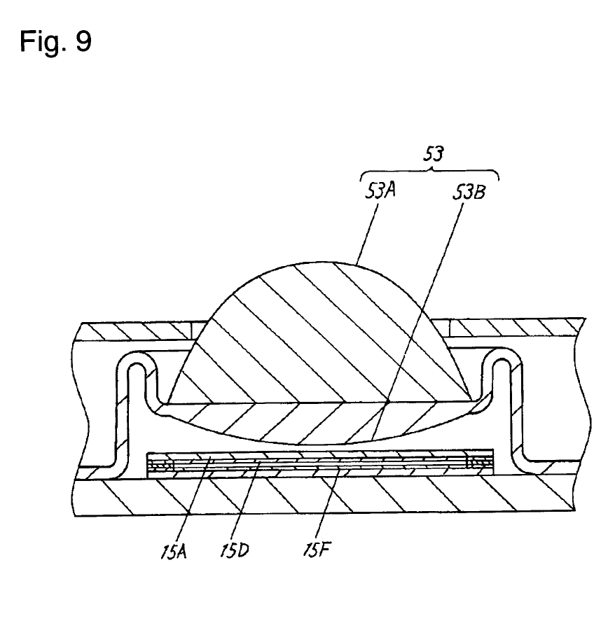

FIG. 9 is a sectional view of a multiple-direction input device in exemplary embodiment 2 of the present invention. Operation body 53 includes a push portion having a substantially spherical shape formed at the bottom of the body. The portion is elastic like an elastomer. That is, this arrangement corresponds to the device of embodiment 1 in that the push portion 13B at the bottom of operation body 13 is elastic.

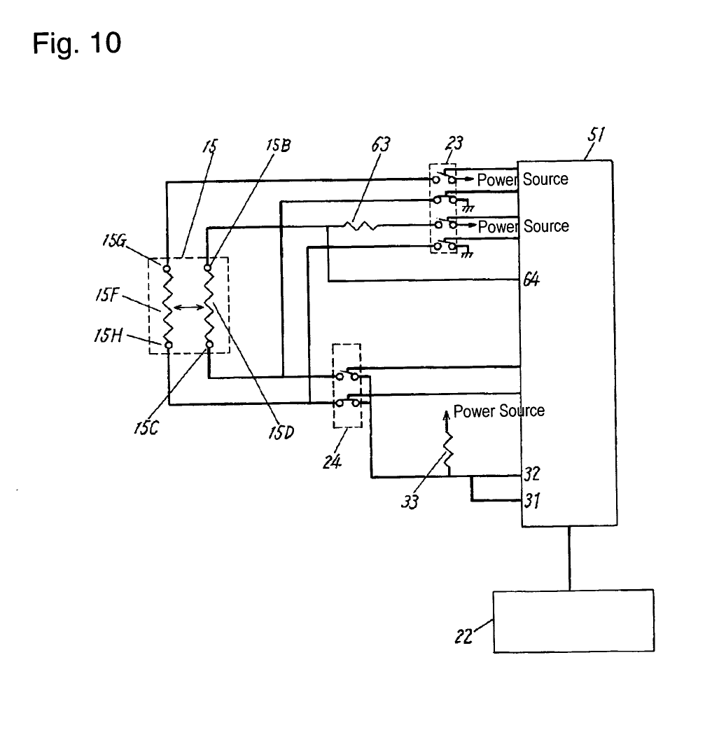

FIG. 10 is a block circuit diagram of an electronic apparatus including the multiple-direction input device. Resistor 63 is disposed between the electrode 15B of upper resistor layer 15D and the power source, and has a resistance of about 1 kΩ. A/D-input terminal 64 reads the analog voltage of the electrode 15B. Other than the above are identical to embodiment 1.

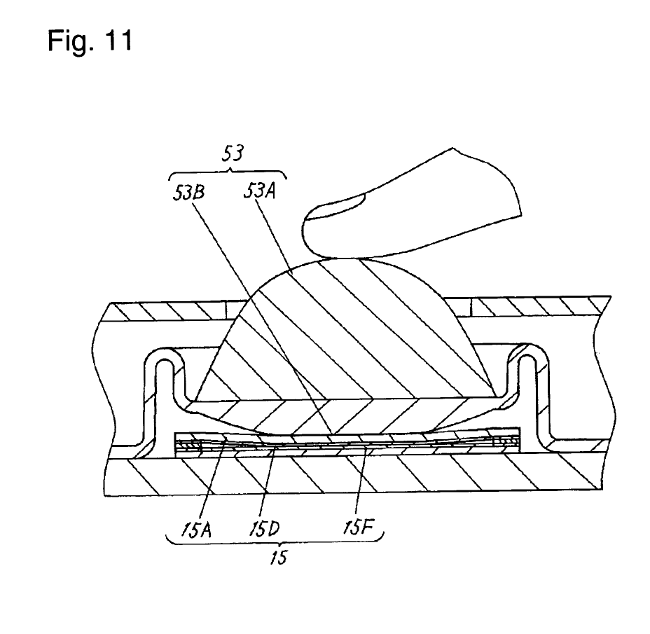

When the operation knob 53A is pushed with a finger or the like, as shown in the sectional view of FIG. 11, the central portion of the push portion 53B pushes the top board 15A, thus causing the central portion of the upper resistor layer 15D underneath the top board 15A to contact the central portion of the lower resistor layer 15F opposing to the layer 15D. Thus, similarly to embodiment 1, microcomputer 51 recognizes the start of pushing operation of the operation body 53, applies a current to the electrode 15C at the ground from the electrode 15B, and reads the voltage of electrode 15C from the A/D-input terminal 32.

Further, in case the operation body 53 is pushed at a higher strength, the contact area between the operation body 53 and the top board 15A increase since the push portion 53B is elastic. Accordingly, since the resistance determined with the upper resistor layer 15D and lower resistor layer 15F decreases, the current flowing in the resistor 63 increases, thus causing the A/D-input terminal 64 to receive a decreased voltage. The microcomputer 51 recognizes a change of the voltage of A/D-input terminal 64 and detects an operation load to the operation body 53.

The detecting the operation load to the operation body 53 enables, for example, a map displayed on the display of an electronic apparatus including the multiple-direction input device to be enlarged and reduced in size with the microcomputer 51 according to the change in the voltage of the A/D-input terminal 64.

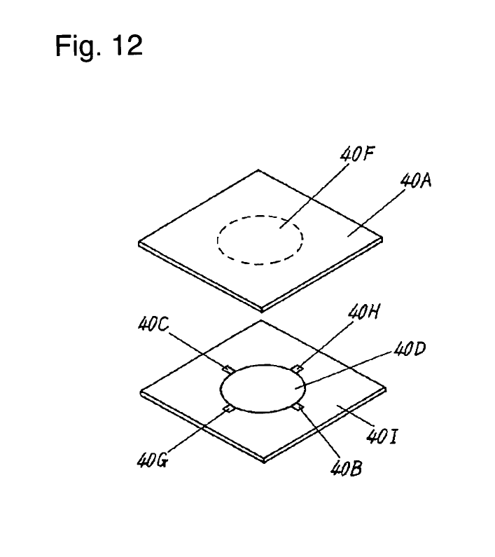

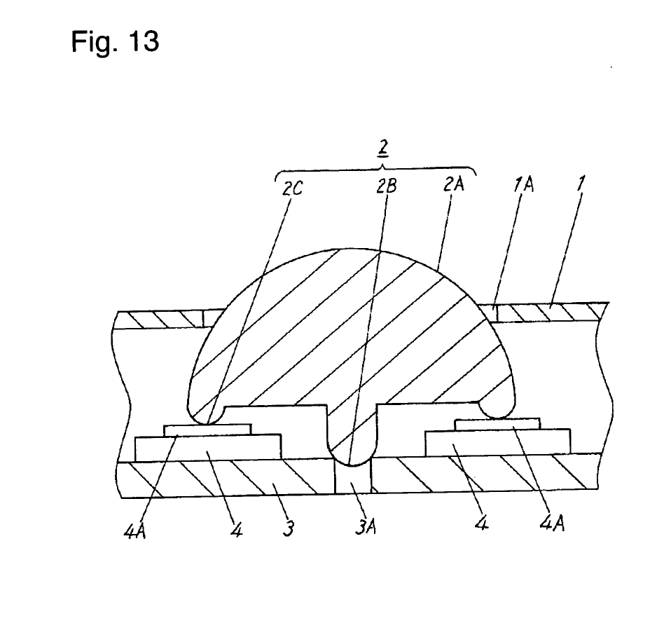

In the above description, in the resistor element 15, the top board 15A having electrodes 15B and 15C at either right and left end of the upper resistor layer 15D is opposing to the bottom board 15I having electrodes 15G and 15H at either front and rear end of the lower resistor layer 15F. As shown in the exploded perspective view of an essential portion of FIG. 12, it is also possible to execute the present invention even in case the resistor element 15 includes four electrodes 40B, 40C, 40G, and 40H disposed at the front, rear, right and left of the resistor layer 40D formed on the upper surface of the bottom board 40I, respectively. The conductive layer 40F on the underside of the top board 40A is opposed to the element 15.

In this case, an operation of the operation body 53 causes the conductive layer 40F on the underside of the top board 40A to contact the resistor layer 40D on the upper surface of the bottom board 40I. The pressing point of the push portion can be detected from the relationship between the resistance across the electrodes 40B and 40C at front and rear and the resistance across the electrodes 40G and 40H at right and left.

According to the invention as described above, a multiple-direction input device is provided using less number of parts and capable of detection in multiple tilting directions and at multiple tilting angles, and an electronic apparatus including the device.

### INDUSTRIAL APPLICABILITY

According to the present invention, a multiple-direction input device is provided using less number of parts and capable of continuous detection in tilting directions and at tilting angles, and an electronic apparatus including the device.

1. A multiple-direction input device comprising:
an operation body having a push portion at a bottom thereof, said push portion having a substantially spherical shape; and
a flat resistor element beneath said operation body, for providing a resistance that changes according to a tilting direction and a tilting angle of said operation body pushed by said push portion.

2. The multiple-direction input device of claim 1, wherein a predetermined space is provided between said push portion and said resistor element.

3. The multiple-direction input device of claim 1, wherein said push portion is elastic.

4. The multiple-direction input device of claim 1, wherein said resistor element comprises:
a first resistor layer; and
a second resistor layer spaced apart and opposed to said first resistor layer, said second resistor layer contacting said first resistor layer at a contacting position when being pushed with said push portion, said contacting position changing in accordance with a position pushed with said push portion.

5. The multiple-direction input device of claim 4, wherein said resistor element further comprises:
two first electrodes opposing to each other and being connected to said first resistor layer; and
two second electrodes opposing to each other in a different direction from an opposing direction of said two first electrodes, said second electrodes being connected to said second resistor layer.

6. An electronic apparatus comprising:
said multiple-direction input device of claim 1; and
a controller for detecting the tilting direction and the tilting angle of said operation body based on the resistance of said resistor element.

7. An electronic apparatus comprising:
said multiple-direction input device of claim 5; and
a controller connected to said first and second electrodes, for detecting and comparing a voltage obtained by applying a voltage between said first electrodes according to the resistance, and a voltage obtained by applying a voltage between said second electrodes according to the resistance.
